(19) United States
(12) Patent Application Publication
(10) Pub. No.: US 2016/0221630 A1
(43) Pub. Date: Aug. 4, 2016

(54) Double-Acting Safety Skewer

(71) Applicant: Leonard Ashman, Folsom, CA (US)

(72) Inventor: Leonard Ashman, Folsom, CA (US)

(21) Appl. No.: 14/610,994

(22) Filed: Jan. 30, 2015

(51) Int. Cl. B62K 25/02

(52) U.S. Cl. CPC B62K 25/02; B62K 2025/025

(57) ABSTRACT

The present invention teaches a novel double-acting skewer that provides sufficient safety tab clearance with a single lever motion without the need to manipulate any other component of the mounting apparatus. Once the apparatus of the present invention has been mounted and adjusted to a specific frame, the wheel may be mounted and dismounted using only the clamping lever. More importantly, once adjusted, the clamping force remains constant and the clamping lever returns to the same location consistently.

The subject of this invention relates to the bicycle industry. More specifically, the disclosed invention teaches a novel hub mounting skewer that compensates for the presence of the mandatory safety tabs on the frame forks of a bicycle. Advantageously, the present invention may be used on both front and rear hubs, as well as on a wide variety of contemporary human powered vehicles including bicycles, both fixed gear and variable cog types, recumbent cycles, and tandems.

### BACKGROUND OF THE INVENTION

Chain driven bicycles have existed for many years. These human powered vehicles come in many forms, for example the classic sitting upright bicycle, recumbent sitting reclined bicycle, tandems, fixed gear, BMX and so on. Each of these is driven by a cog and chain means. Generally the chain receives power input from a peddle crank that has a rotational motive force exerted upon it from a rider's legs. The force is transferred by the chain to the driven wheel via a geared chain-ring/cog combination, for example, wherein the cog is in turn mechanically linked to a hub. The hub is attached to the drive wheel by means of spokes or solid inserts such as in the so-called disk wheels. The drive wheel may be located at the front or the rear of the human powered vehicle. In this way linear force from a rider's legs is transformed to rotational force applied to the driven wheel and then to the road surface. A second, non-drive wheel is generally present at the end of the vehicle opposite the driven wheel.

From time to time the wheels of a bicycle must be detached from the bicycle frame, for example, to change a flat tire or to replace a worn part. There exist many contemporary methods for attaching a wheel to the bicycle frame. One method uses a solid axle threaded on both ends, generally found in the BMX type bicycle. Once the axle ends have been located correctly in the frame lugs, the nuts are tightened to fix the wheel in place. A second method uses a hollow axle through which a rod, referred to in the art as a skewer, is run. One end of the skewer has a lever and the other end an adjustable nut. Once the wheel is in the correct position in the lugs of the bicycle frame the lever is operated which results in a clamping force to fix the wheel in place. This latter method represents the majority of wheel mounting techniques in use today.

While these methods are functional, they suffer from a common flaw. In both cases the rider must perform multiple steps to remove the wheel from the bicycle frame to perform service. In the first case, a wrench or pair of wrenches must be used to loosen both nuts, then the nuts run out away from the frame lugs prior to removing the wheel. In the case of the lever operated skewer, once the tension on the skewer rod has been released by operating the lever, the nut on the opposite side from the lever must be loosened further, or run out in order to clear the frame lugs to allow removal of the wheel for service. In all cases the nut(s) on the apparatus must be operated sufficiently to clear the safety tabs mandated by regulatory policy. These tabs, so called lawyer tabs, are in place to prevent a wheel from slipping out of the frame lugs if the mounting apparatus has inadvertently become loosened, for example by road vibration or improper installation.

Once the wheel is clear, maintenance can occur. But the same problems exist in reverse upon remounting of the wheel. For the case of the solid axle, the wheel must be inserted into the frame lugs, then each of the nuts run in to fix the wheel in place, then a wrench or pair of wrenches must be applied to both nuts to firmly secure the wheel in place. For the case of the lever operated skewer, the wheel must be located in the frame lugs, then the nut run in to the approximate position required to engage the lever, then the rider must operate the lever to see if the nut is in the correct position. This process must be repeated several times in order to ensure proper capture of the hub in the bicycle frame with the appropriate clamping force. As can be seen, both of these methods require numerous steps and are very inefficient.

What would be desirable is a method for mounting/dismounting a bicycle wheel that eliminates the need for the user to deal with nuts or inefficient lever mechanisms. The apparatus of the present invention provides an improved wheel mounting/dismounting method that accomplishes this as well as eliminating other problems related to the prior art methods discussed above.

### SUMMARY OF THE INVENTION

The present invention teaches a novel double-acting skewer that provides sufficient safety tab clearance with a single lever motion without the need to manipulate any other component of the mounting apparatus. Once the apparatus of the present invention has been mounted and adjusted to a specific frame, the wheel may be mounted and dismounted using only the clamping lever. More importantly, once adjusted properly, the clamping force is repeatable and the clamping lever returns to the same location consistently.

The apparatus of the present invention is comprised of three main components: a skewer rod, a clamping nut and a double-acting cam-and-lever mechanism. The clamping nut and skewer rod are of the contemporary type, with the significant difference that the skewer rod is threaded on both ends in order to provide a wide range of adjustment to accommodate a similarly wide range in frame lug separation.

The double-acting cam-and-lever mechanism is a sub-assembly further comprised of a cam housing, a cam housing cap, a cam actuator, a double-acting cam and a clamping lever. The double-acting cam is permanently attached to the clamping lever such that when the clamping lever is rotated the double-acting cam follows the same rotational movement. The double-acting cam is located within a sliding cam actuator such that when rotational movement occurs by the double-acting cam [hereinafter dacam] the sliding cam actuator moves laterally in response.

In turn, the sliding cam actuator is permanently attached to a first end of a skewer rod via threads on that first end. As the sliding cam actuator moves laterally in response to the rotation of the dacam, the skewer rod follows. The second end of the skewer rod has a threaded section that is mated to a clamping nut. As the skewer rod moves in response to the sliding cam actuator, a clamping force is either applied or removed depending on the direction of the skewer rod travel. The length of the travel of the skewer rod is such that a gap sufficient to clear the safety tabs on a bicycle frame is created, allowing the wheel to be dropped out without further intervention by the rider.

Of importance is that the apparatus of the present invention has both a very repeatable gap and a very repeatable clamping force, thus once the apparatus has been properly fitted to a specific bicycle frame, it may be removed and replaced repeatedly without any need for adjustment of the various components. Due to the double action of the cam, even if the clamping lever should become accidentally displaced, the wheel will remain mounted. This is due to the fact that upon initial operation of the clamping lever only a portion of the dismounting gap is created. It is the second, or double action of the clamping lever that provides the gap needed. As well as the advantages discussed above, other advantages of the present invention are discussed below in conjunction with the drawings and figures attached.

### BRIEF DESCRIPTION OF THE DRAWINGS

FIG. 1: is an example of a prior art lever operated skewer apparatus.

FIG. 2: is an exploded isometric view of the improved fixed gap skewer apparatus of the present invention.

FIG. 3: is a detailed exploded isometric view of the double-acting-cam of the improved fixed gap skewer apparatus of the present invention.

FIG. 4A: is an isometric view of the double-acting cam of the improved fixed gap skewer apparatus present invention.

FIG. 4B: is a cross-sectional view of the double-acting cam of the improved fixed gap skewer apparatus present invention.

FIG. 5A: shows a cross-sectional view of the improved fixed gap skewer apparatus of the present invention in the in-use state.

FIG. 5B: shows a cross-sectional view of the improved fixed gap skewer apparatus of the present invention in the clamping pressure partially released state.

FIG. 5C: shows a cross-sectional view of the improved fixed gap skewer apparatus of the present invention in the clamping pressure fully released state.

FIG. 5D: shows a cross-sectional view of the improved fixed gap skewer apparatus of the present invention in the clamping pressure released safety state.

FIG. 5E: shows a cross-sectional view of the improved fixed gap skewer apparatus of the present invention with the clamping pressure fully released and removal gap created state.

FIG. 5F: shows a cross-sectional view of the improved fixed gap skewer apparatus of the present invention in the locked open state.

### DETAILED DESCRIPTION OF PREFERRED EMBODIMENTS

As described briefly above, the improved fixed gap skewer apparatus of the present invention provides a number of advantages over the prior art, including importantly both safety and efficiency. To best understand the advances made by the present invention it is important to understand the prior art methods used. Note that while the method of using a pair of clamping nuts and a solid axle is still in use, particularly on BMX and fixed gear bicycles, it will not be discussed in detail since those skilled in the art will recognize the rudimentary characteristics of this method.

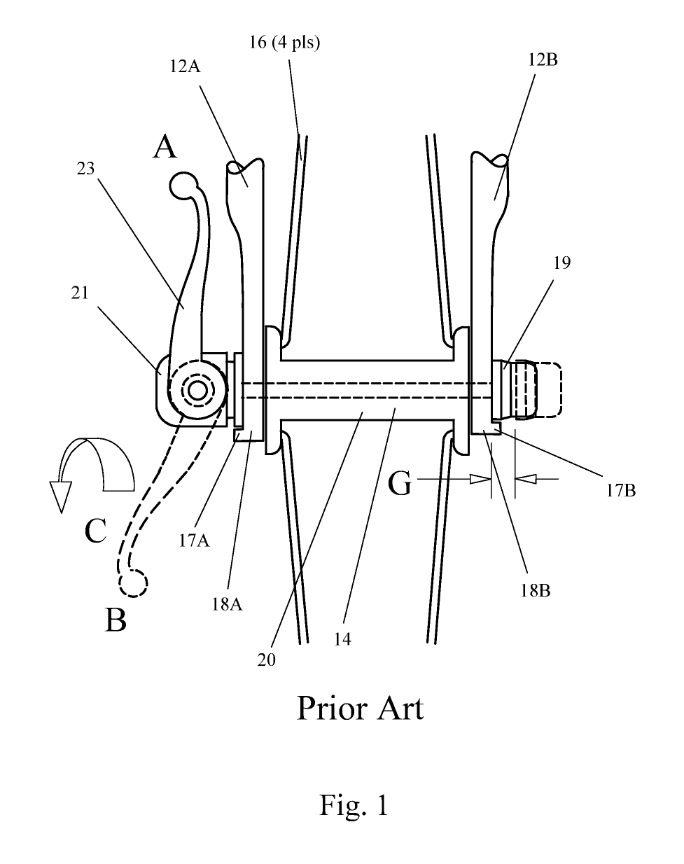

Looking at FIG. 1 the most commonly used contemporary wheel mounting apparatus is shown. A bicycle wheel hub 14, in this case a non-driven wheel, has a number of spokes 16 radiating from the hub flanges. These spokes attach to a rim (not shown for clarity) upon which is mounted a tire. Note that while a non-driven wheel is shown, the same theory applies to driven wheels as well, and moreover, to wheels that use discs or tri-spoke configurations. The salient point is that a hub is attached to a rim in some manner, forming a wheel that needs to be mounted to the frame of a bicycle. Note also that while the term “bicycle” is used throughout, the principles discussed herein apply to a plurality of human powered vehicles including recumbent cycles, tandems, unicycles, fixed gear bicycles, and certain types of amputee vehicles such as wheel chairs and hand operated racing chairs.

The wheel formed by hub 14 and spokes 16 have a skewer assembly comprised of clamping nut 19, skewer rod 20, and lever sub-assembly 21. When in use the lever 23 is in position A. A cam internal to the lever sub-assembly 21 applies a pulling force on the skewer rod 20 such that when in position A the wheel is firmly mounted in the lugs 18A and 18B of the frame forks 12A and 12B. It will be recognized by those of skill in the art that the internal cam of lever sub-assembly 21, while not discussed here in detail, is of the single acting type common in the industry.

Still looking at FIG. 1, each of the frame forks 12A and 12B have associated with them a safety tab 17A and 17B respectively. These safety tabs 17A and 17B, referred to contemporarily as lawyer tabs, are proscribed by law in order to insure that the wheel remains mounted—albeit loosely—to the frame of the bicycle if the lever 23 inadvertently becomes loosened. These tabs protrude outward from the frame lugs at a distance of approximately 0.1 inch preventing the wheel from completely dismounting during operation, for example from vibration as a result of traversing a rough road surface.

In order for a rider to remove the wheel from the bicycle, for example, to fix a flat tire, the lever 23 must first be moved approximately 180 degrees from position A to position B to release the clamping pressure. Once the clamping pressure has been released, the lever 23 must be turned counter-clockwise in direction C a number of times [while holding the clamping nut 19] to create the gap G needed to allow the wheel to clear the safety tabs 17A and 17B. Depending on the specific bicycle configuration, the rider may be required to turn the lever up to six or more times.

Supposing now that the tire has been repaired and that the wheel is ready to be remounted, the rider places the wheel in the frame lugs 18A and 18B, then turns the lever 23 a number of times clockwise to re-clamp the wheel into the frame. Unfortunately, since the number of turns completed to dismount the wheel is random, and since the cam in the lever sub-assembly 21 is only single acting, it may take several attempts to re-achieve the proper setting for the skewer assembly. Additionally, even if the rider manages to get the number of turns correct on the first try, there is no guarantee that the lever 23 will return to the proper orientation without having to mess about with the clamping nut 19. Returning to the proper orientation is important since it is highly undesirable to have the lever interfere with other bicycle components or with an adjacent bicycle, for example, in a race. In all, the trial-and-error method of remounting a wheel is highly inefficient and leaves a lot to be desired.

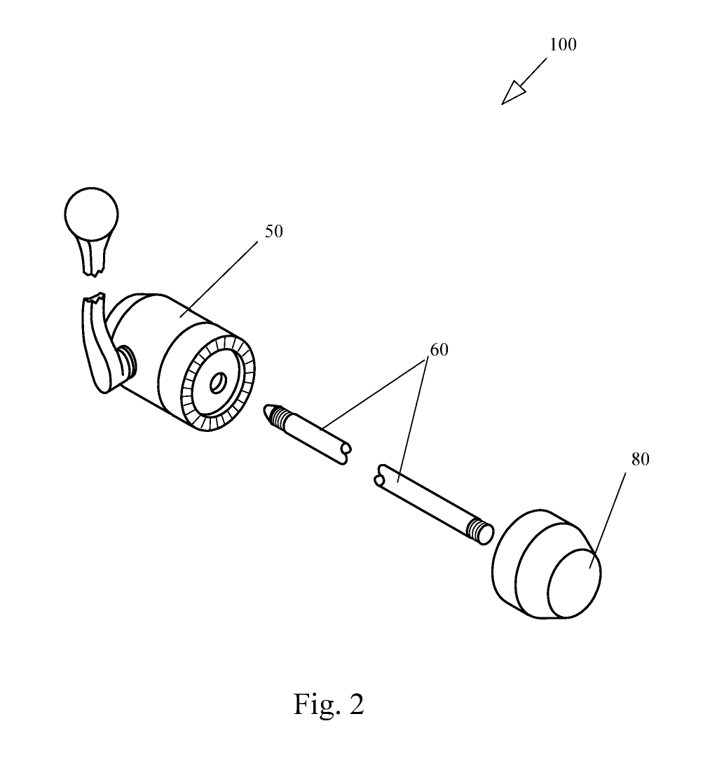

FIG. 2 shows an apparatus 100 according to the present invention that solves the shortfalls of the prior art methods discussed. As with prior art methods, a clamping nut 80 in tandem with a skewer rod 60 is used to provide the clamping force needed under the influence of a cam located within a cam housing assembly 50. While the clamping nut 80 used here is a MemoryNut™ from Liberty Wheel Systems, LLC, Folsom, Calif., it will be recognized by those of skill in the art that any suitable clamping nut could be used without departing from the spirit of the invention. For example, but not meant as a limitation, a stainless steel or titanium nut could be used.

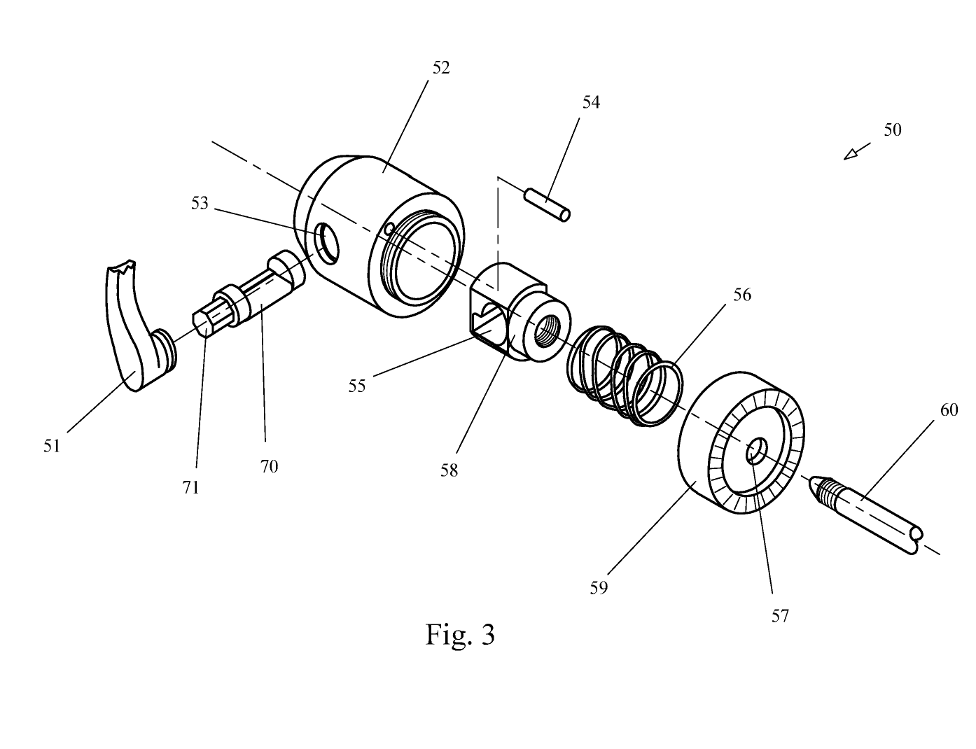

As discussed in detail below in conjunction with FIG. 3, a cam located within cam housing 50 is double acting, providing an improvement in both safety and efficiency. Of note is that the lever associated with the cam housing 50 need only be operated once. There is no need to first release the clamping pressure then rotate the lever to create the requisite gap to clear the safety tabs. Instead, the double-acting cam (dacam) located within cam housing 50 first releases the pressure in a first opening motion and then creates the requisite gap on a second, continuous opening motion. This double action is a significant advance in the art.

Referring now to FIG. 3, the cam housing assembly 50 is shown in detail in an isometric view. A cam housing shell 52 has a hole 53 in one side through which the dacam 70 is inserted. In a preferred embodiment of the present invention the cam shell housing 52 is made from aluminum; however, it will be recognized by those of skill in the art that other materials, for example titanium, could be used without departing from the spirit of the invention. A lever 51 has an interference fit about a hexagonal stub 71 on the end of the dacam 70. Once in place, a retaining pin 54 ensures that the lever 51 and dacam 70 do not slip out of the cam housing shell 52.

In a preferred embodiment of the present invention the lever 51 is made from aluminum; however, it will be recognized by those of skill in the art that other materials, for example titanium, could be used without departing from the spirit of the invention. Dacam 70 of the current invention is made from hardened steel, for example heat treated B4A2 stock. This harder material is used to ensure that the lever 51 and skewer rod 60 do not wear the surface of the cam or the hexagonal stub 71. Skewer rod 60 is made from stainless steel.

Also inside the cam shell housing 52 is a cam actuator 58. The cam actuator 58 has a cavity 55 through which dacam 70 may be inserted. When properly assembled, as lever 51 is rotated, dacam 70 also rotates inside the cam actuator cavity 55 causing the cam actuator 58 to move in a lateral direction in response to the rotational motion of lever 51. In a preferred embodiment of the present invention the cam actuator 58 is made from steel; however, it will be recognized by those of skill in the art that other materials, for example heat treated aluminum, could be used without departing from the spirit of the invention.

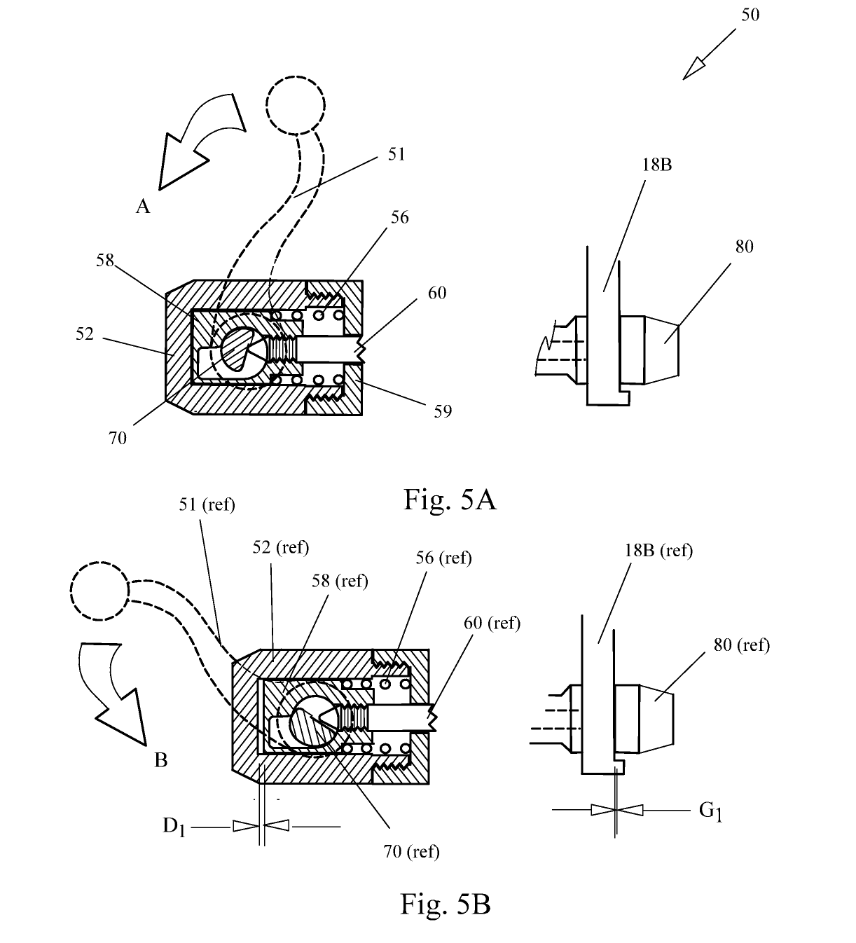

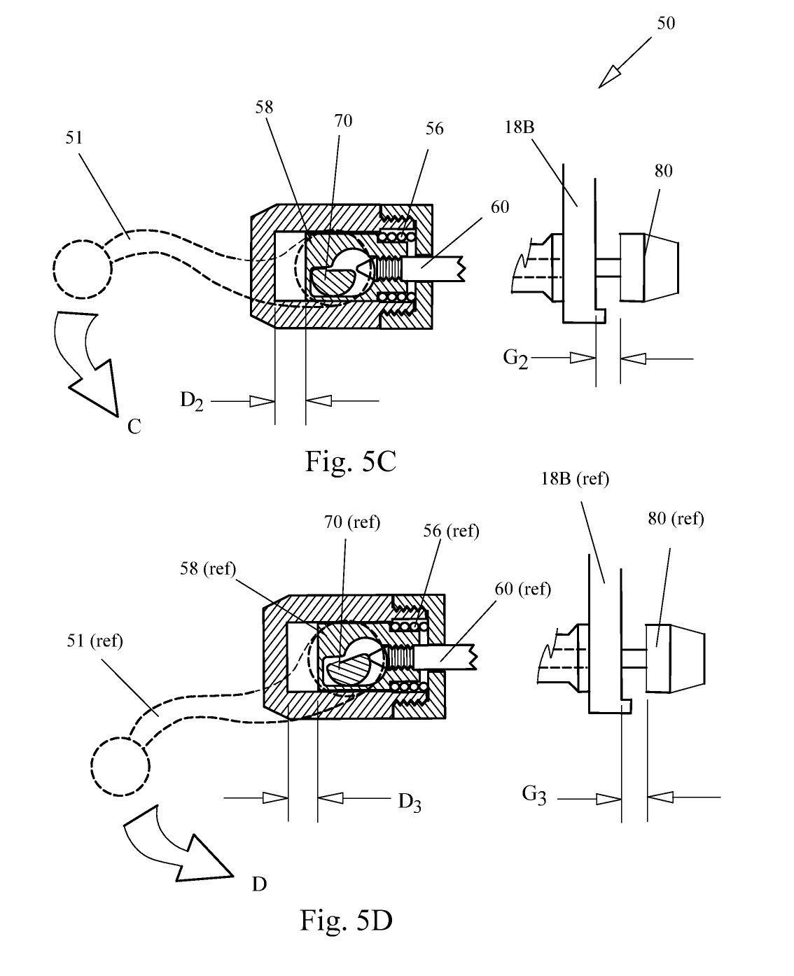

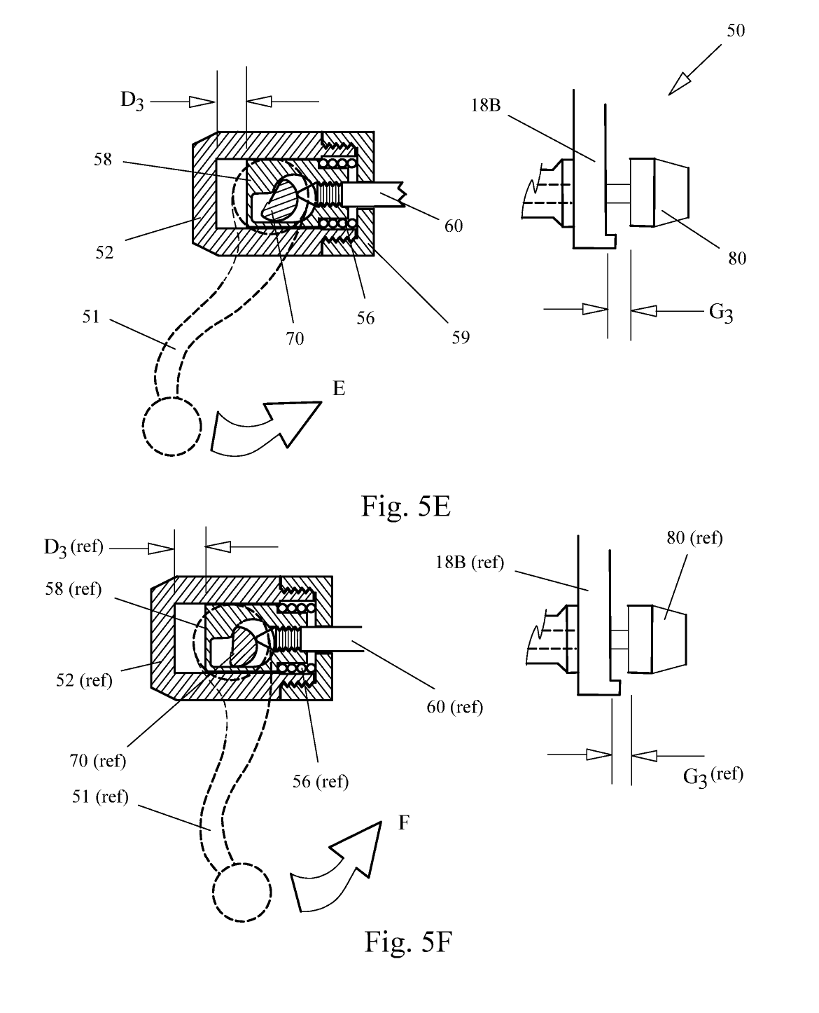

The apparatus of the present invention is completed when release spring 56 is fitted about the collar of cam actuator 58 and cam housing cap 59 is threadably attached to cam shell housing 52. Skewer rod 60 passes through a hole 57 in cam housing cap 59 and threadably attaches to cam actuator 58. As cam actuator 58 moves laterally in response to a rotational movement of lever 51 skewer rod 60 and cam housing shell 52 move laterally with respect to each other ultimately creating a gap sufficient to allow a bicycle wheel to clear the safety tabs on a bicycle frame as explained in detail in conjunction with FIG. 5A through 5F below.

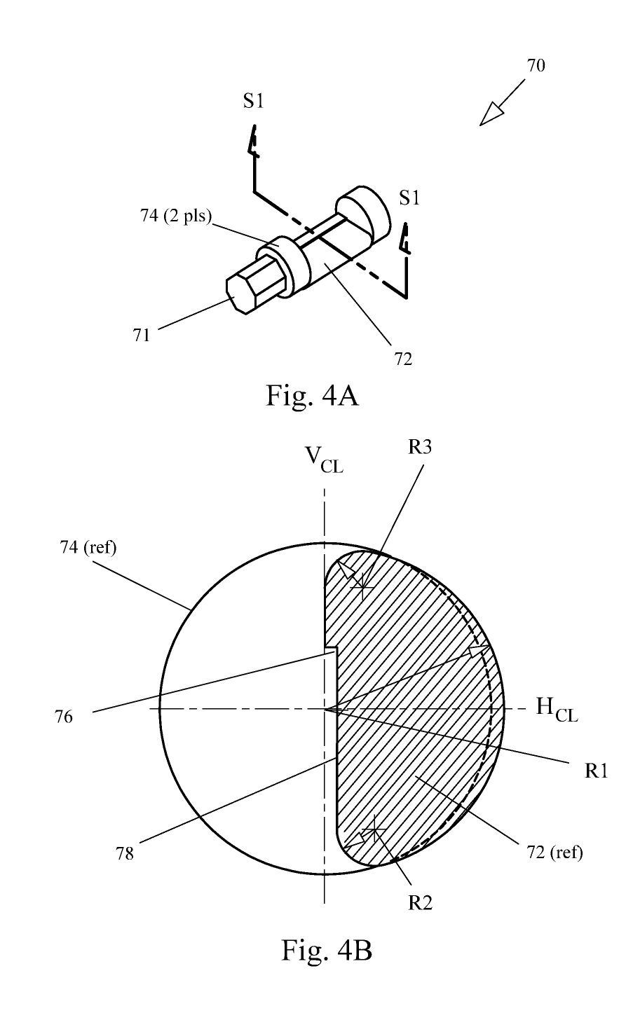

FIG. 4 provides the details of the geometry of dacam 70. As will be understood through an analysis of FIGS. 5A through 5F below, the dacam 70 is key to the operation of the improved fixed gap skewer apparatus of the present invention. In FIG. 4A the dacam 70 is shown in an isometric view with a section line S1-S1 looking towards the end of the dacam opposite the hexagonal stub 71. As can be seen, dacam 70 is comprised of three parts: a hexagonal section 71, two narrow cylindrical sections 74 and a double-acting cam section 72. The double-acting cam section 72 is double acting in that its profile is comprised of a plurality of radii. Taken together the plurality of radii act to both lock the wheel in place for use and provide the requisite gap for dismounting without the need to manipulate the clamping nut [80 in FIG. 2] or the lever [51 in FIG. 2].

The hexagonal section 71 of dacam 70 is used as a mounting pin for the lever [51 in FIG. 2]. The two narrow cylindrical sections 74 function both to locate the dacam 70 inside the cam housing [52 of FIG. 3] and to provide a rotational bearing surface about which the lever can turn. Finally, the double-acting cam section 72 of dacam 70 provides the surface against which a first end of a skewer rod [80 in FIG. 2] operates.

Turning to FIG. 4B, a cross sectional view of the dacam 70 is shown. The narrow cylindrical section 74 (one of two) is shown with its center at the intersection of vertical centerline V_{CL} and horizontal centerline H_{CL}. This is the rotation point for the dacam 70. A double-acting cam section 72 is offset from the center point of the narrow cylindrical section 74. The offset creates locking ridge 76 used to lock the apparatus in the closed, or in-use position. Major radius R1 is the primary lobe of dacam 70 providing the lateral movement required to create the gap required to bypass the safety tabs on a bicycle frame. In a preferred embodiment, major radius R1 is 0.137 inches. Minor radii R2 and R3 are required to compensate for the offset allowing the dacam 70 to rotate inside the cam actuator [58 of FIG. 3]. In a preferred embodiment of the present invention, minor radii R2 and R3 are 0.04 inches. The flat surface 78 of dacam 70 is used to allow the rounded tip of the skewer rod [60 in FIG. 3] to slide and eventually seat against the locking ridge 76. In combination the major radius 72, the flat surface 78 and the locking ridge 76 function as both the force to needed to keep a wheel mounted in the frame of a bicycle and to create the required gap for removal, thus the dacam 70 is double-acting.

Turning now to FIGS. 5A through 5F the operational details of the present invention are discussed. Beginning with FIG. 5A, the apparatus of the present invention 50 is shown in the in-use, or mounted position. Lever 51 has been moved to the locked closed, or wheel mounted orientation. In the mounted position clamping nut 80 is hard against frame fork 18B, thus no gap exists between the two.

Note that while the lever 51 is shown in a vertical orientation, it is not mandatory that the locked closed position be vertical. Pragmatically, the lever 51 could be in any orientation and is shown in the vertical only because, as a matter of practice, most riders prefer this orientation. Note also that the lever 51 is shown in dotted lines in order to more clearly illustrate the internal details of the present invention.

In the locked closed position dacam 70 has been wedged between the inner surface of the cam actuator 58 and the tapered tip of skewer rod 60. In obtaining this position a release spring 56 has been completely decompressed such that only a minimal lateral force exists on the face of the cam actuator 58. The cam actuator 58 is free to slide laterally inside cam housing 52. The cam actuator 58 and the release spring 56 are held in place by cam housing cap 59. To begin the dismounting operation the rider will rotate the lever 51 in direction indicated by the arrow A.

In FIG. 5B the rider has moved the lever 51 further in a counter-clockwise direction indicated by arrow B. Dacam 70 has moved away from the locked position and skewer rod 60 is moving along the flat surface of dacam 70. Cam actuator 58 has begun a lateral movement towards the frame of the bicycle which releases pressure between clamping nut 80 and frame lug 18B. At the same time a small distance D1 has formed between the cam actuator and the inside of the cam shell 52 causing release spring 56 to compress slightly. Note that while the cam actuator has moved distance D₁, the clamping nut 80 also moves a similar distance G₁ due to the fact that the cam actuator and the skewer rod 80 are threadably connected, thus they move in concert. At this time the wheel may be loose, but the spring loaded cam housing shell 52 and cam in combination with the safety tabs prevent the wheel from being dismounted from the bicycle frame.

Looking at FIG. 5C, the rider has moved the lever 51 further in a counter-clockwise direction as indicated by arrow C to the point where the minor radius [R₂ in FIG. 4B] of the dacam 70 is just about to move past the tapered end of skewer rod 60. Note that the skewer rod 60 has a tapered end to allow the dacam 70 to easily pass without sticking or binding. At this point in the dismounting process the release spring 56 remains fully compressed, and the cam actuator 58 has reached its widest distance D2. At this point the gap G₂ between the clamping nut 80 and the frame lug 18B is sufficient to allow the wheel to clear the safety tabs and drop away from the frame of the bicycle.

Referring now to FIG. 5D, the rider has continued to move the lever 51 in direction D until the tip of the skewer rod 60 has just slipped past the minor radius of dacam 70. As the skewer rod 60 is urged along the face of the major radius [R1 of FIG. 4B] of dacam 70 the distance D₃ between the cam actuator 58 and the inner wall of the cam housing and the gap G₃ between the clamping nut 80 and the frame lug 18B remain constant.

In FIG. 5E lever 51 has been moved in the direction of arrow E such that the major radius of dacam 70 [R1 in FIG. 4B] is keeping a constant gap G₃ between the clamping nut 80 and the frame lug 18B by the force applied to skewer rod 60. In this state, a gap of at least 0.21 [or 0.105 inches on either side of the apparatus] inches has been created which is sufficient to clear the safety tabs on the fork of a bicycle frame. At this point in time the release spring 56 is fully compressed between the cam actuator 58 and the cam housing cap 59 and the distance D₃ between the cam actuator 58 and the cam housing 52 remains the same. This is the state of the apparatus just prior to being locked into the open position.

FIG. 5F shows the locked open state of the apparatus. Here the lever 51 has been moved in the direction of arrow F until the lever 51 is approximately vertical. Dacam 70 has been wedged between the inner surface of cam actuator 58 and the tip of skewer rod 60 such that the tip of skewer rod 60 maintains the gap G₃ between the clamping nut 80 and the frame lug 18B and the distance D₃ between the cam actuator 58 and the inner wall of the cam housing 52. Release spring 56 remains fully compressed. In this state the wheel will drop free of the bicycle frame since the gap G₃ is sufficient to clear the safety tabs without further manipulation of the clamping nut 80 or the lever 51.

Still referring to FIG. 5F, remounting the wheel uses the reverse process just described above in conjunction with FIGS. 5A through 5F. It is worthy of note that when the rider places the wheel back in the frame lugs and releases the lever 51 from the locked state, the release spring 56 urges the cam actuator 58 towards the closed end of cam shell 52, causing the gaps G₃ and D₃ to close to the gaps G₂ and D₂ of FIG. 5C. In this state the wheel will no longer drop out of the frame lugs, assisting the rider in the remounting process, improving further the efficiency of the present invention. It will be understood that continuing the closing motion of the lever 51 will cause the wheel to once again be properly mounted in the frame lugs of the bicycle, for example 12A and 12B of FIG. 1. Of importance is the fact that no manipulation of the clamping nut is required since the double acting cam provided the requisite clearance to remove/replace the wheel. This makes the present invention far superior to contemporary skewer apparatuses.

One advantage of the present invention is that a wheel on a bicycle may be removed from the frame lugs without the need to be concerned about clearing the safety tabs. The apparatus of the present invention is able to do this through the use of a double-acting cam that creates a gap sufficient to clear the safety tabs without the need to manipulate the clamping nut or the release lever.

A second advantage of the present invention is that once the apparatus has been properly installed, the captive nut used to create the clamping pressure no longer needs to be manipulated. This means that each time the wheel is removed and replaced all that need be done is operate the lever of the apparatus. When reinstalling the wheel to the bicycle the lever will repeatedly apply the proper clamping force without the need to readjust the clamping nut.

A third advantage of the present invention is that is has a spring loaded intermediate state that ensures that, even if the lever is inadvertently opened, the wheel will remain located in the lugs of the bicycle frame. A second motion of the lever of the apparatus is used to lock the improved skewer open in order to drop the wheel away from the frame of the bicycle.

A fourth advantage of the present invention is that it may be used for both front and rear mounting skewers. This is so since the double-acting cam mechanism that creates the required gap is contained entirely in the lever housing.

What is claimed is:

1. An improved double-acting bicycle wheel safety skewer, the improvement comprising:
a cam housing on a first end of a skewer rod said cam housing containing a double-acting cam connected to a lever, said double-acting cam having at least a major radius and a minor radius, said cam housing also having a first hole for receiving a retaining pin and a second hole for said double-acting cam to pass through;
a cam actuator, said cam actuator having a cavity through which said double-acting cam extends and an internal thread into which said first end of said skewer rod is threadably attached;
a release spring located between said cam actuator and a cam housing cap, said cam housing cap having a centered hole though which said first end of said skewer rod is fed;
a retaining pin;
a captive nut assembly threadably attached to a second end of said skewer rod such that when said lever on said first end of said skewer rod is operated to a first position a minor radius of said double-acting cam contained within said cam housing releases the captive force on the frame lugs of a bicycle frame by urging said cam actuator in a lateral direction causing said skewer rod and said captive nut assembly to move laterally a fixed distance, said fixed distance insufficient to clear the safety tabs on said frame lugs of said bicycle, while further moving said lever to a second position, a major radius of said double-acting cam contained within said cam housing causes a further lateral movement of said cam actuator causing said skewer rod and said captive nut to move a sufficient distance allowing the wheel to clear the safety tabs of said frame lugs of said bicycle.

2. The cam housing, cam housing cap and lever of claim 1 wherein said cam housing, cam housing cap and lever are made from aluminum.

3. The cam housing, cam housing cap and lever of claim 1 wherein said cam housing, cam housing cap and lever are made from titanium.

4. The double-acting cam, retaining pin and skewer rod of claim 1 wherein said double-acting cam, retaining pin and skewer rod are made from stainless steel.

5. The captive nut of claim 1 wherein said captive nut is made from stainless steel.

6. The captive nut of claim 1 wherein said captive nut is made from aluminum.

7. The fixed gap of claim 1 wherein said fixed gap is at least 0.21 inches.

8. The double-acting cam of claim 1 wherein the major radius is 0.137 inches and the minor radius is 0.04 inches.
